(19) United States
(12) Patent Application Publication
(10) Pub. No.: US 2025/0200147 A1
(43) Pub. Date: Jun. 19, 2025

(54) INTEGRATING WEB3 ASSET ATTRIBUTES WITH WEB2 SYSTEMS

(71) Applicant: SAP SE, Walldorf (DE)

(72) Inventors: Rohit Mukund DESHPANDE, Fremont, CA (US); Scott YOUNG, Palo Alto, CA (US); Narek ASADORIAN, Los Angeles, CA (US); Elias ANDREW, Seattle, WA (US); Aria NIAZI, Rocklin, CA (US); Keyoni McNAIR, Redwood City, CA (US)

(21) Appl. No.: 18/538,355

(22) Filed: Dec. 13, 2023

(51) Int. Cl. G06F 21/10; G06F 16/958; G06F 21/60

(52) U.S. Cl. CPC G06F 21/1014; G06F 16/958; G06F 21/602

(57) ABSTRACT

Systems include reception of a request at a Web server to create a Web3 asset on a Web3 database, the Web3 asset associated with metadata of one or more attributes and, in response to the received request, generation of an operation to create the Web3 asset on the Web3 database and transmission of the operation to the Web3 database. An instruction is received at the Web server to assign the Web3 asset to a user, an identifier of the user is stored in association with an identifier of the Web3 asset and the metadata, a user request to claim a benefit of one of the attributes is received at the Web server, it is determined at the Web server that the user is associated with Web3 asset based on the stored user identifier, and the benefit is provided to the user in response to the determination.

### BACKGROUND

The development of Web3-based assets presents new opportunities to enterprises. To date, widespread use of these assets is limited by the technical expertise required to create, manage and interact therewith.

For example, a typical enterprise administrator is not capable of manually generating transactions for creating and managing Web3 assets and storing those transactions on a Web3 database such as a blockchain. Even if an enterprise administrator could successfully create a Web3 asset and transfer that asset to a user, the user would require an understanding of cryptographic keys, digital wallet management, transactions, etc. in order to interact with and manage their asset. Although interfaces for interacting with blockchains and digital wallets exist, these interfaces are geared toward technically-adept users and can intimidate or confuse novice users.

Assuming an enterprise could successfully provide Non-Fungible Tokens (NFTs) to users, the resulting value accruing to the enterprise would be speculative and limited. The NFTs do not have significant practical use or monetary worth and therefore fail to create appreciable goodwill toward the enterprise. Moreover, contact between the enterprise and a user essentially terminates after an NFT is provided to the user.

It is therefore desirable to provide an intuitive system to create, manage, distribute and claim Web3 assets which provide benefits to users. These benefits may promote loyalty or other desirable behavior. Such a system may provide familiar interface metaphors to users of the assets and to administrators who create and manage the assets.

### BRIEF DESCRIPTION OF THE DRAWINGS

FIG. 1 is a block diagram of a system to manage Web3 assets using Web2 technology according to some embodiments.

FIG. 2 is a flow diagram of a process to create a custodial tenant wallet according to some embodiments.

FIG. 3 is a flow diagram of a process to generate a Web3 asset including benefits according to some embodiments.

FIG. 4 is a user interface for submitting Web authentication credentials according to some embodiments.

FIG. 5 is a user interface for specifying metadata of a Web3 asset according to some embodiments.

FIG. 6 is a user interface for specifying benefits of a Web3 asset according to some embodiments.

FIG. 7 is a user interface presenting metadata of a Web3 asset according to some embodiments.

FIG. 8 is a user interface presenting metadata for claiming a Web3 asset according to some embodiments.

FIG. 9 is a user interface for distributing a Web3 asset according to some embodiments.

FIG. 10 is a flow diagram of a process for claiming a Web3 asset according to some embodiments.

FIG. 11 is a user interface for claiming a Web3 asset according to some embodiments.

FIG. 12 is an e-mail including a link for claiming a Web3 asset according to some embodiments.

FIG. 13 is a user interface for claiming a Web3 asset including benefits according to some embodiments.

FIG. 14 is a flow diagram of a process for creating a Web3 asset on a blockchain according to some embodiments.

FIG. 15 is a flow diagram of a process for transferring a Web3 asset from a custodial tenant wallet to a user wallet according to some embodiments.

FIGS. 16a and 16b comprise user interfaces for transferring a Web3 asset from a custodial tenant wallet to a user wallet according to some embodiments.

FIGS. 17a through 17d are representations of a database table of a Web2 data store storing associations between Web3 assets, users and digital wallets according to some embodiments.

FIG. 18 is a detailed block diagram of a system to manage Web3 assets using Web2 technology according to some embodiments.

FIG. 19 comprises code of a remote signing utility according to some embodiments.

FIG. 20 is a block diagram of a system according to some embodiments.

### DETAILED DESCRIPTION

The following description is provided to enable any person in the art to make and use the described embodiments. Various modifications, however, will be readily-apparent to those in the art.

Embodiments may facilitate integration of standard and customizable attributes into NFTs, thereby enhancing their utility, personalization, and/or intrinsic value. Web2 interfaces and backend systems may be used to facilitate creation, distribution, and use of benefit-providing NFT attributes without an understanding of the intricacies of the Web3 environment or blockchain technology. Embodiments may be blockchain-agnostic and provide creators the flexibility to mint NFTs having benefit-providing attributes across various blockchain platforms.

Benefits according to some embodiments may take various forms, such as but not limited to access rights to digital content, event access, voting rights within a digital community, virtual goods, and real-world rewards. A system may include predefined standard attributes as well as creator-customizable attributes. Customizable attributes can be tailored to specific preferences, needs or interests of a particular NFT owner or group of NFT owners. Such tailoring may increase an NFT's appeal to the particular owner or group and also enhance its value proposition.

According to some embodiments, NFT owners access and claim attribute-driven benefits directly via Web2 technologies, incentivizing increased engagement with the related enterprise. If an NFT is sold or otherwise transferred to a new owner, any benefits associated therewith become usable by the new owner, maintaining the integrity and value of the NFT. In this regard, embodiments ensure that only the legitimate owner of an NFT can claim and use its associated benefits, further enhancing the appeal and value of the NFT.

Embodiments may therefore increase the value, versatility, functionality, and user-centricity of NFTs. This approach allows for differentiation from competitor enterprises, potentially attracting more attention and higher NFT values. Moreover, by enabling users to shape their own experiences via NFT benefits, embodiments may make Web3 technologies more accessible and appealing to non-technical users, thereby contributing to the democratization of the Web3 ecosystem.

Many attribute types are contemplated for use in conjunction with some embodiments. A Digital Twin attribute links an NFT to a product. A user can either claim the product after purchasing the NFT or receive the NFT after purchasing the product. The administrator may specify a royalty which is paid to the NFT creator upon resale. A Gated Access attribute allows an NFT to be used for ongoing or one time access to online or real-world events. Metadata of a Gated Access attribute may define one or more events and, for each event, a name, identifier, link, and type (i.e., online/offline).

An Unlockable Prize attribute can be updated to another attribute type in the future. The metadata may specify a link to a page with instructions to unlock the prize, a maximum unlock count, an updated image, etc. An Easter Egg attribute is assigned to different NFTs which are to be collected together in order to unlock a prize (e.g., money, donation, product, recognition, access). The metadata of an Easter Egg attribute may include identifiers of the other NFTs to be collected therewith. Similarly, a Cobrand Experience attribute may be assigned to NFTs of different communities and companies which are to be collected together to unlock a prize. The metadata may specify identifiers of the other NFTs to be collected and a number of the other NFTs required for various prizes.

A Charity Donation attribute facilitates a donation to charity, allowing a user to select a charity to which a donation will be made. An administrator may specify metadata for a Charity Donation attribute including a name, link, and wallet address of each of several charities, a donation schedule, a prerequisite to the donation (e.g., product purchase), and whether to record the donation on a blockchain.

A Community Membership attribute provides membership to a community. The community may comprise a non-profit organization, a company loyalty program or any other group. On a related note, a Voting Rights attribute enables an NFT to be used for voting on an issue, for a candidate, etc. A Rarity Trait attribute is used to make an NFT rare and potentially valuable. A Rarity Trait attribute is assigned a name, a type (e.g., string, number, percent) and a value.

A Product Provenance attribute specifies information pertaining to sustainability and origins of an associated product. Similarly, a Sustainable Blockchain attribute may specify that an NFT is minted on a sustainable block chain which, for example, leverages proof-of-stake as a consensus mechanism and/or tracks all transactions and leverages carbon offsets to achieve carbon neutrality.

Other attribute types provide general information regarding NFTs themselves. For example, a Web3 Ownership attribute provides a link to information regarding ownership of digital assets in the cloud and the ability to transfer assets to a user's own cryptographic wallet. A Web3 Ecosystem attribute includes a link to a description of the advantages and capabilities of Web3 and its ecosystem, including marketplaces, automated market makers, and user wallets. Similarly, a Cryptographic Security attribute provides a description of the attributes of Web3 cryptographic security.

A Counterfeit Protection attribute may inform a user that an NFT is counterfeit-proof due to the ability to cryptographically check the ownership of a Web3 asset. A Digital Collectable attribute provides information regarding the desirability of collecting NFTs in a personal wallet, watching their values grow over time, and selling them in a marketplace. A Metaverse Compatible attribute indicates that an NFT is compatible with Metaverse standards. Embodiments are not limited to the attribute types and corresponding benefits described above. Moreover, each attribute type may be customized and new attribute types may be created according to some embodiments.

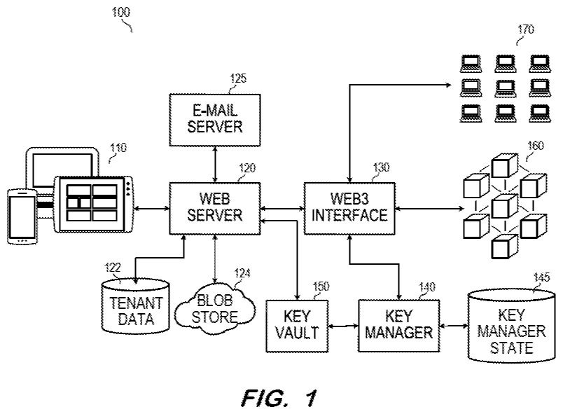

FIG. 1 is a block diagram illustrating system 100 to manage Web3 assets using Web2 technology according to some embodiments. Each of the illustrated components may be implemented using any suitable combination of computing hardware and/or software that is or becomes known. In some embodiments, two or more components are implemented by a single computing device. Two or more components of system 100 may be co-located. One or more components may be implemented as a cloud service (e.g., Software-as-a-Service, Platform-as-a-Service). A cloud-based implementation of any components of system 100 may apportion computing resources elastically according to demand, need, price, and/or any other metric.

Each component may comprise, for example, comprise a single computer server, a virtual machine, or a cluster of computer servers such as a Kubernetes cluster. Kubernetes is an open-source system for automating deployment, scaling and management of containerized applications. Each component of system 100 may therefore be implemented by one or more servers (real and/or virtual) or containers. Each data storage component depicted herein may comprise one or more storage systems, each of which may be standalone or distributed, on-premise or cloud-based.

System 100 includes user devices 110 which may be operated by administrators or users of a customer, or tenant. Each of user devices 110 may include a Web browser compatible with Web2 protocols. For example, a Web browser of a user device 110 may request and receive Web pages from Web server 120 and/or execute code of a browser application (which may or may not conform to a user interface framework loaded in the browser) to interact with a corresponding server application executed by Web server 120 to present user interfaces.

User devices 110, Web server 120 and tenant data 122 generally conform to the frontend, backend, and database paradigm of a Web2 architecture. The frontend enables user interaction and requests and receives data from the backend. The backend is a centralized server that receives requests from the frontend, fetches data from the database, and returns the response to the frontend to be displayed. All of the data is stored in the database, which is also a centralized entity.

An administrator or user may provide authentication credentials (e.g., username and password) to Web server 120 via an interface presented by a user device 110. Web server 120 executes its server application to perform an authentication process based on the credentials, receive requests from the administrator or user, and provide tenant data 122 in response to the requests and based on data authorizations granted to the administrator or user. The server application may provide any functionality that is or becomes known, including but not limited to the enterprise resource planning functionalities noted above.

According to some embodiments, an administrator interacts with Web server 120 using interfaces presented on a Web client of a user device 110 to create metadata describing a Web3 asset. The administrator may also specify data associated with the Web3 asset. For example, an administrator may specify the name and attributes of an NFT and an image file associated with the NFT. The specified attributes of an NFT may provide one or more benefits as described herein. Web server 120 may store the metadata and data of the NFT in association with an identifier of the NFT and a wallet identifier in tenant data 122.

The administrator may further interact with Web server 120 to specify e-mail addresses of users to whom the NFT should be distributed. Accordingly, also stored in tenant data 122 may be a list of e-mail addresses to which the NFT was distributed.

A user may receive such an e-mail via their e-mail client application and access Web server 120 using a link provided in the e-mail. The user then interacts with Web server 120 using interfaces presented on a Web client of a user device 110 to claim the NFT. As a result, an identifier of the user is stored in tenant data 122 in association with the identifier of the NFT to indicate that the user “owns” the NFT. Since tenant data 122 also includes metadata of the NFT which describes attributes of the NFT, storage of the user identifier in association with the identifier of the NFT also facilitates providing the user with the benefits associated with those attributes.

Blob store 124 may be cloud-based and may provide storage at a lower cost than comparable file-based storage systems. Web server 120 may store unstructured data such as NFT images in blob store 124. Accordingly, if a user requests to view the data and metadata of an NFT which they own, Web server 120 may retrieve the corresponding metadata data from tenant data 122 and the data image from blob store 124 and present it to the user without accessing Web3 storage. Accesses to tenant data 122 and blob store 124 using Web2 protocols are typically much faster and reliable than accesses to Web3 storage due in part to the asynchronous nature of Web3 protocols.

Web server 120 may also use e-mail server 125 to transmit e-mails to intended recipients as mentioned above. The e-mails may include a link which may be selected to authenticate a user directly to Web server 120 to claim a Web3 asset. E-mail server 125 may be provided by a party different from a provider of Web server 120 and Web3 interface 130.

Web server 120 may request generation of a cryptographic keypair (e.g., a public key and a private key) from key vault 150. Key vault 150 generates the keypair, stores the keypair and returns an identifier of the keypair (e.g., a wallet identifier) to Web server 120. The wallet identifier may comprise the public key of the keypair in some embodiments. Web server 120 may store the wallet identifier in tenant data 122.

The request to generate a keypair may be issued in response to a request received by Web server 120 to create a tenant. A tenant may represent a customer organization, and employees of the organization may be considered users of the tenant. Accordingly, Web server 120 may store the returned identifier of the keypair in association with an identifier of the tenant. In some embodiments, an application executed by Web server 120 may comprise a multi-tenant application, in which case Web server 120 may request generation of a respective keypair for each of several tenants. Web server 120 stores a returned identifier of each generated keypair in association with an identifier of its respective tenant.

Key vault 150 may be provided by an entity different from another one or more entities operating the other components of system 100. Advantageously, the other entities are unable to access the private keys of the keypairs generated by key vault 150. Rather, key vault 150 may only be requested to sign a transaction on behalf of a tenant using its private key and to provide the signed transaction in return.

For example, Web server 120 generates an RPC call specifying a database operation (e.g., a transaction) and transmits the RPC call and a custodial tenant wallet identifier identifying a cryptographic keypair to Web3 interface 130. Web3 interface 130 provides the transaction and the wallet identifier to key manager 140. Key manager 140 then requests key vault 150 to encrypt (i.e., sign) the transaction using the private key associated with the wallet identifier. Key manager state information 145 may associate wallet identifiers with addresses of primary keys within key vault 150 and may therefore be used to facilitate the request to key vault 150.

Key vault 150 encrypts the transaction with a private key associated with the wallet identifier (e.g., using the secp256k1 elliptic curve scheme and the ECDSA signing algorithm), and returns the thusly-signed transaction to key manager 140. Web3 interface 130 submits the signed transaction to blockchain 160 by executing a predetermined JSON RPC call which corresponds to the RPC call received from Web server 120. Key manager 140 may transform the transaction prior to providing the transaction to key vault 150 so that the resulting signed transaction received from key vault 150 conforms to a format acceptable to blockchain 160.

According to some embodiments, the signed transaction generated by Web3 interface 130 may comprise a transaction to create a collection on a blockchain, to create an NFT of a collection on the blockchain, to transfer an NFT from one digital wallet to another digital wallet, to add attribute values to an NFT, etc. For example, Web3 interface 130 receives metadata (describing, among other things, the attributes of the NFT) and data of an administrator-defined NFT from Web server 120 and generates and transmits a signed blockchain transaction to blockchain 160 to mint the NFT on blockchain 160. Moreover, Web3 interface 130 executes Web3 protocols to transmit the metadata and data to decentralized storage 170. Web3 interface may also operate per instructions from Web server 120 to generate and transmit signed blockchain transactions to blockchain 160 to transfer ownership of an NFT from a custodial tenant wallet to a user wallet.

According to Web3 architecture, each block on a blockchain is composed of transactions. Before a transaction can be included in a block, it must be executed by a virtual machine associated with the block chain, such as the Ethereum Virtual Machine (EVM). The EVM runs on top of the blockchain to execute transactions between users and smart contracts and compute the new state resulting from those interactions. The newly-computed state becomes the base for a new block.

Smart contracts are programs that contain logic written in specifically-purposed languages. The code and variables of a smart contract are deployed and stored on the blockchain. A smart contract deployed to the blockchain is uniquely identified and accessed by its address. An address can identify a smart contract or an externally-owned account. Externally-owned accounts are controlled by users and smart contracts are controlled by code, although both can hold balances and interact with smart contracts.

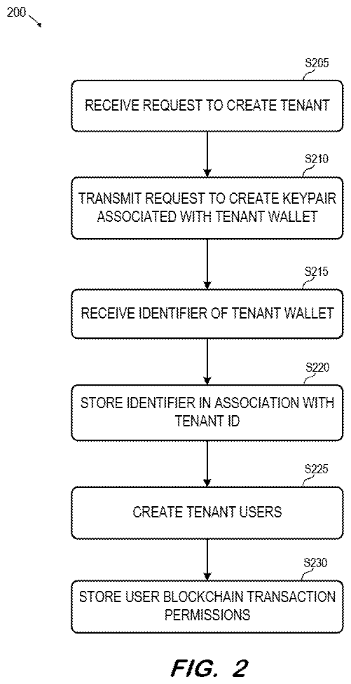

FIG. 2 comprises a flow diagram of process 200 to create a custodial tenant wallet according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a microprocessor, a microprocessor core, and a microprocessor thread. Embodiments are not limited to the examples described below.

Initially, at S205, a request is received to create an application tenant. The request may be received, for example, by a Web2 server such as Web server 120 from a Web browser executing on a user device such as user devices 110. According to some examples, an administrator operates a Web browser of a user device to access a Uniform Resource Locator associated with an application executed by Web server 120 and to subsequently interact with the application to request creation of a tenant as is known in the art.

Assuming the administrator is authenticated to the application and authorized to create a tenant, a request is transmitted at S210 to create a keypair associated with a wallet of the tenant. The request may be transmitted to a key vault from which the provider of the application is not permitted and is unable to retrieve private keys. The key vault generates a keypair associated with the wallet and returns an identifier of the wallet at S215. As noted above, the identifier of the wallet may comprise the public key of the keypair.

The wallet identifier is stored in association with an identifier of the new tenant at S220. For example, Web server 120 may store a record including the wallet identifier and the tenant identifier in tenant data 122. S225 may include creating users associated with the tenant by defining user identifiers and corresponding authentication credentials. Flow continues to S230 to store blockchain transaction permissions for respective users of the tenant. For example, user identifiers may be stored at S230 in association with data specifying the types of blockchain transactions which the respective users are permitted to perform.

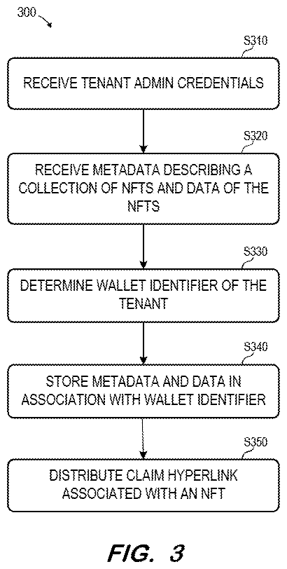

FIG. 3 is a flow diagram of a process to generate an NFT according to some embodiments. Advantageously, the metadata and data of an NFT may be generated without requiring the creator to be familiar with blockchain technology.

Credentials of a tenant administrator are received at S310. For example, an administrator may operate a Web browser to access a Uniform Resource Locator associated with digital asset management functionality of an application executed by a Web server as is known in the art.

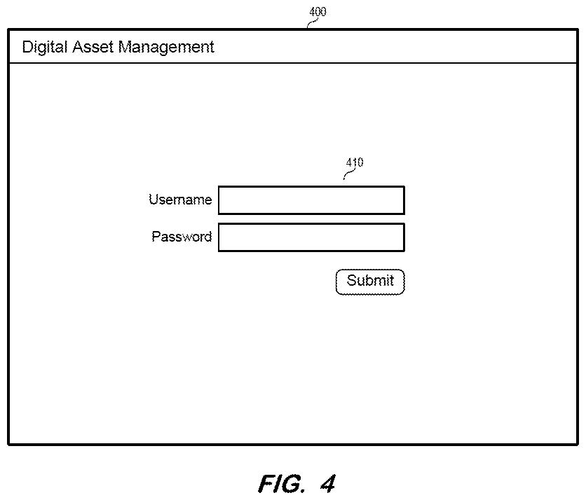

FIG. 4 illustrates user interface 400 which may be presented to the administrator as a result. User interface 400 includes input fields 410 for receiving login credentials (i.e., username and password) at S310. Authentication may proceed according to any suitable procedure, including looking up the login credentials in a database table of credentials, and multi-factor authentication. Assuming authentication is successful, flow proceeds to S320 to receive metadata describing a collection of NFTs and data of the NFTs.

FIG. 5 illustrates interface 500 of a Web2 application to receive metadata and data describing a collection of NFTs from an administrator at S320 according to some embodiments. The present example describes the creation of NFTs within collections. Attributes specified by the administrator according to the present example apply to all NFTs of the collection. Embodiments are not limited to this paradigm. Rather, an administrator may create an NFT independent of any collection if allowed by the blockchain on which the NFT is to be created, and different NFTs of a given collection may be associated with different attributes according to some embodiments.

Collection details input area 510 of interface 500 allows the administrator to provide metadata of a collection of NFTs to be created, including descriptive information and technical details (e.g., blockchain, Token standard) to which the collection is to conform. Input area 520 accepts hyperlinks and image data associated with the collection. NFT details input area 530 includes fields for providing a name and a description of an NFT of the collection and data (i.e., image data) associated with the NFT.

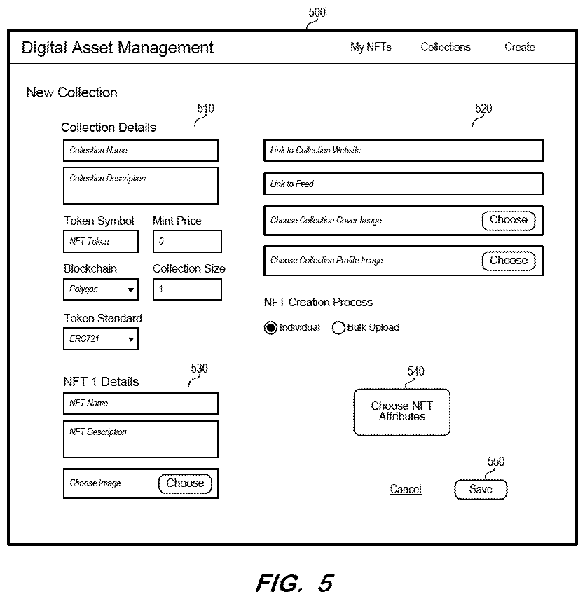

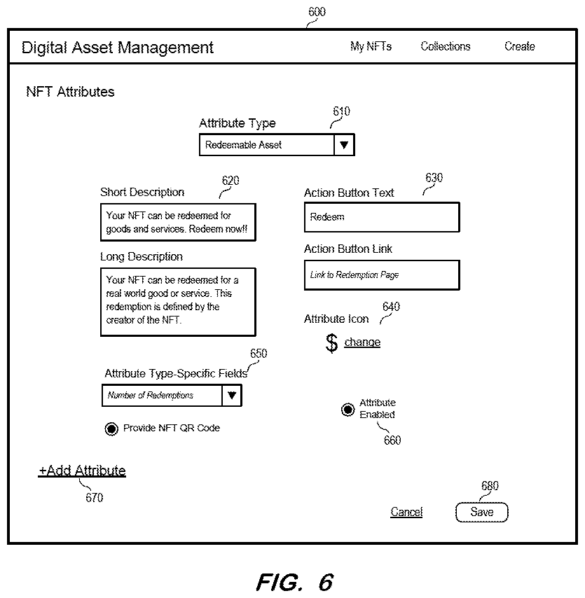

Interface 500 also includes control 540, which may be selected to add attributes to the NFTs of the collection. Selection of control 540 results in display of interface 600 of FIG. 6. Interface 600 includes drop-down menu 610 for selecting a type of the attribute to be added to the NFTs of the current collection. Drop-down menu 610 may be populated with several standard attribute types. Selection of a standard attribute type may result in population of the other fields of interface 600 with data corresponding to the selected attribute type. Drop-down menu 610 may also allow selection of a custom attribute type, in which case the administrator populates the other fields of interface 600 as desired.

Input fields 620 receive text descriptions of the benefits provided by the selected benefit type. In the present example, the attribute type “Redeemable Asset” is selected in menu 610. According to some embodiments, an owner of an NFT associated with an attribute of the “Redeemable Asset” attribute type may use the ownership to redeem physical goods (e.g., beverages at a concert, a t-shirt at a conference). Input fields 620 are therefore populated in response to selection of the attribute type with short and long text descriptions corresponding to these benefits.

The text descriptions may be presented to a user while viewing an NFT including the attribute. An attribute may also be presented along with a selectable user interface control, or action button. Fields 630 of interface allow the administrator to specify the text of the action button and a link which is accessed upon user selection of the action button. Again, the text of the button may be pre-populated based on the selected attribute type. More than one action button may be associated with an attribute, including a button with the text “Learn More” and an associated link to a page with details of the attribute. Attribute icon field 640 indicates an icon which is displayed to a user along with the NFT and may also be pre-populated. The icon and the text of all other pre-populated fields of interface 600 may be changed by the administrator as desired.

It will be assumed that attributes of all types are defined using fields 620-640. Some attributes may, however, be associated with attribute type-specific fields 650. In the case of the selected attribute type shown in FIG. 6, fields 650 include a drop-down menu to specify a number of permitted redemptions of the corresponding benefit, and a radio button to indicate whether to provide a QR code for redemption of the benefit. Attribute type-specific fields 650 may vary depending on the attribute type selected in menu 610.

Radio button 660 allows the administrator to specify whether the benefit of the attribute should be accessible to users. Radio button 660 allows, for example, an attribute to be defined in advance but only made accessible to users after the corresponding NFTs are assigned to users. The administrator may select link 670 to add another attribute to the collection. Any number of attributes may be added according to some embodiments. As will be described below, each attribute of a collection of NFTs will be presented to a user viewing an NFT of the collection. The attached attributes may be presented to the user in a priority order to limit display clutter.

In some embodiments, if a custom attribute type is created in interface 600, the administrator may be presented with an option to add the custom attribute type to drop-down menu 610 for future selection. Selection of save control 680 returns the administrator to interface 500, and selection of Save control 550 of interface 500 causes submission of the data input into interfaces 500 and 600 for reception at S320.

Next, at S320, a wallet identifier associated with the current tenant is determined. The wallet identifier may be stored by the Web2 application during creation of a keypair corresponding to the tenant as described above. The metadata and data received at S320 are stored in association with the wallet identifier at S340. For example, Web server 120 may create a record in a table of tenant data 122 associating the wallet identifier with the metadata of the collection and of its NFTs. The record may include an identifier of the tenant or any other suitable information. Web server 120 may store the data (e.g., the image data) received at S320 in blob store 124 according to some embodiments. The above-mentioned record of tenant data 122 may further include object identifiers of the stored data in blob store 124 to facilitate retrieval thereof.

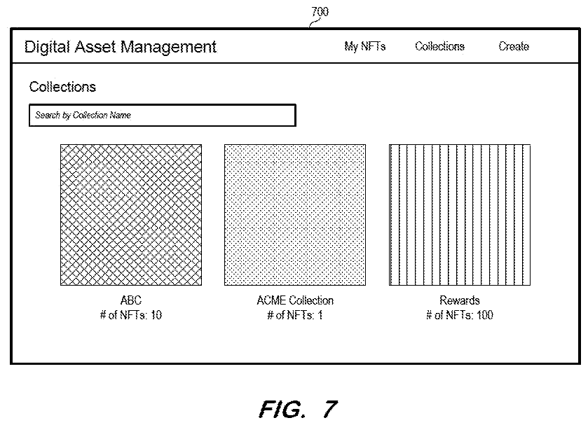

User interface 700 of FIG. 7 may be presented to the administrator based on metadata and stored by the Web2 backend. In particular, tenant data 122 may store metadata of the three collections presented by user interface 700 in association with an identifier of the current tenant. The tenant identifier is used to retrieve the metadata as well as the associated image data from blob store 124.

For example, it is assumed that the administrator selects collection “ABC” from interface 700. Interface 800 of FIG. 8 is presented in response, including the retrieved metadata and image data 810 associated with the selected collection. Manage tab 820 of interface 800 is selected, which allows the administrator to specify text to be presented on a Web interface for users to whom an NFT is distributed. Manage tab 820 also includes a link and a QR code for accessing the Web interface.

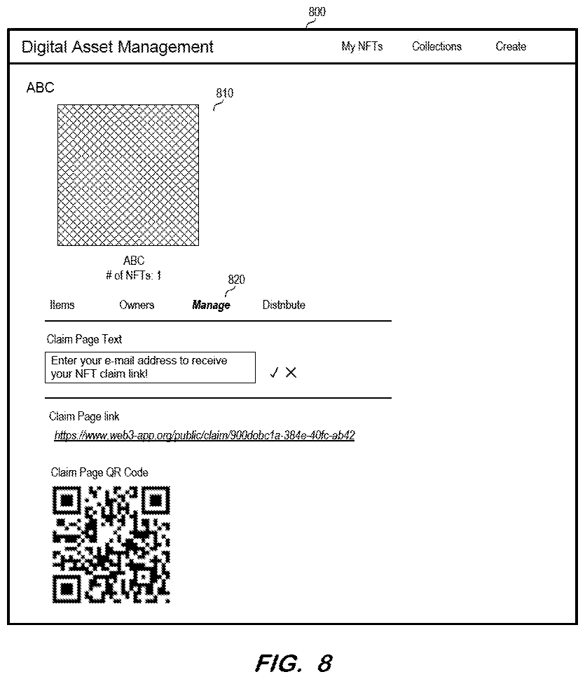

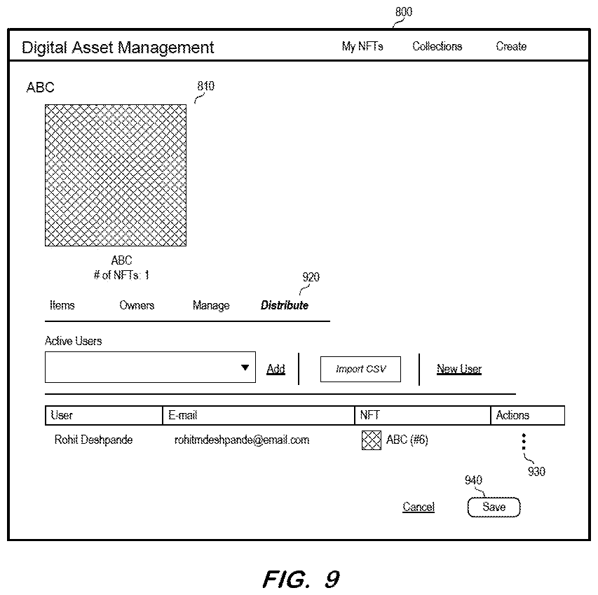

The administrator may further interact with Web server 120 to distribute a hyperlink associated with the collection at S350. FIG. 9 shows interface 800 after selection of Distribute tab 920. Distribute tab 920 includes controls for specifying one or more users and their associated email addresses. Actions control 930 may be operated to select an NFT of the collection to offer to a specified user. In the present example, NFT #6 of the ABC collection has been associated with the specified user.

Selection of Save control 940 causes e-mailing of a hyperlink to each specified user for claiming the NFT associated with the user. Web server 120 may utilize e-mail server 125 to send the e-mail at S350. The hyperlink may comprise the links shown in Manage tab 820 and may be accompanied by the text shown therein. Tenant data 122 may also be updated to associate the metadata of each distributed NFT with an identifier of the user to whom the NFT was distributed. This association may be subsequently used to determine whether a user attempting to claim an NFT is the same user to whom the NFT was distributed (i.e., to whom the hyperlink was e-mailed).

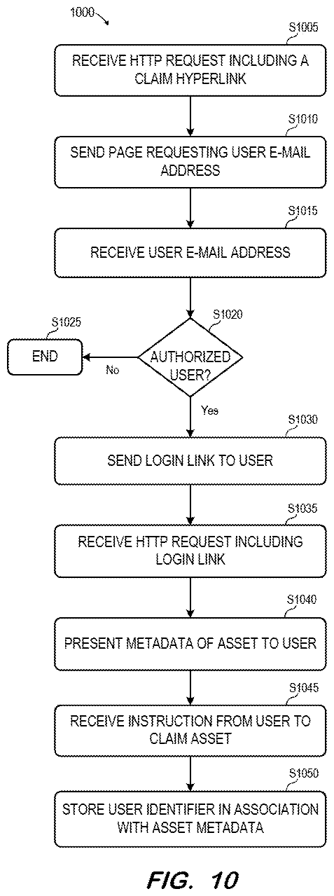

FIG. 10 is a flow diagram of process 1000 for claiming a Web3 asset according to some embodiments. Prior to process 1000, a user initiates an HTTP request including a hyperlink for claiming a Web3 asset. The hyperlink may be transmitted to the user via an e-mail as described above. In some embodiments, the user scans a QR code (i.e., which is publicly available or otherwise directed to the user) including the hyperlink to initiate the HTTP request. The HTTP request is received (e.g., by Web server 120) at S1005.

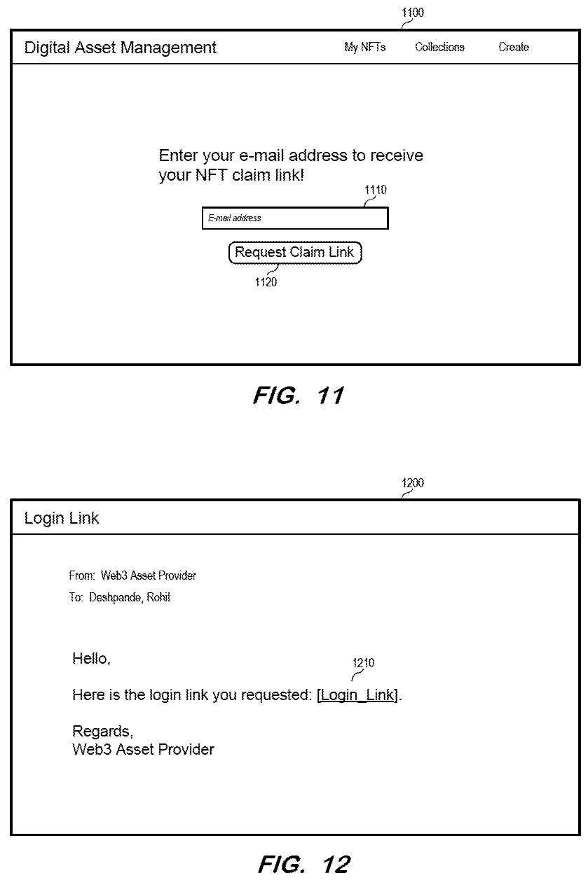

A Web page or other interface is sent to the user at S1010 in response to the HTTP request. The Web page includes a request for the user's e-mail address. FIG. 11 illustrates Web page 1100 sent at S1010 and presented by a Web browser of a user device. Web page 1100 includes the text specified in the Manage tab 820 of FIG. 8 and input field 1110 for receiving the user's e-mail address. The user submits their e-mail address into field 1110 and selects control 1120 thereafter.

The user e-mail is received at S1015. At S1020, it is determined whether the user is an authorized user of the tenant. The authorization may comprise any authorization method that is or becomes known, including checking the received e-mail address against a list of authorized e-mail addresses. Flow terminates at S1025 if the user is not an authorized user.

If the user is authorized, an e-mail including a login link is sent at S1030 to the e-mail address received at S1015. In the case of system 100, Web server 120 may use e-mail server 125 to send the e-mail. The login link may comprise a “magic” link which facilitates passwordless authentication to the asset-claiming functionality of a Web2 server. The login link may identify the user and also identify the Web3 asset to be claimed by the user.

FIG. 12 illustrates e-mail 1200 which may be sent at S1030 in some embodiments. E-mail 1200 includes selectable login link 1210. User selection of link 1210 causes reception of an HTTP request including the link at S1035. Metadata of an asset is presented to the user in response to the HTTP request at S1040.

According to some embodiments of S1040, the Web3 asset identified by the login link of the received HTTP request is determined. Next, a check may be performed to confirm that the Web3 asset is associated (e.g., within tenant data 122) with the user identified in the login link.

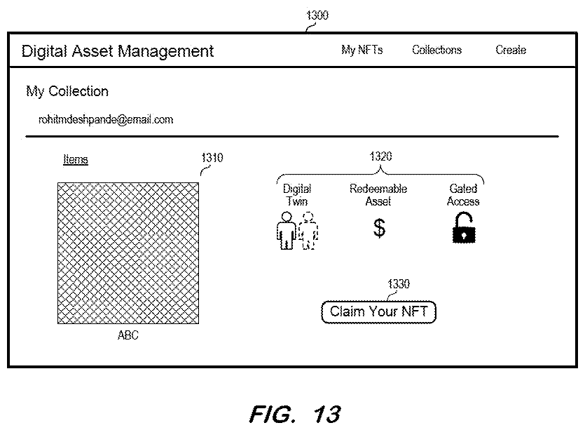

FIG. 13 illustrates interface 1300 which may be presented at S1040. Interface 1300 presents “ABC” and image 1310 of the NFT to be claimed. Interface 1300 also presents metadata 1320 of attributes associated with the NFT. Metadata 1320 may include any suitable metadata, including but not limited to a short description of the benefit provided by each attribute. The metadata and image data of interface 1300 may be retrieved from tenant data 122 and blob storage 124 based on an identifier of the NFT. Interface 1300 also includes control 1330 which the user may select to transmit an instruction to claim the NFT. The instruction is received at S1045.

In response to the instruction, an identifier of the user is stored in association with the stored metadata of the asset at S1050. Storage of this association in tenant data 122, for example, allows Web server 120 to determine that the user has claimed the NFT, without requiring a query of the blockchain. This association may also be used to determine the user's entitlement to the benefits provided by the attributes of the NFT, again without requiring a query of the blockchain. Consequently, the user may log in to Web server 120 in the future to view the metadata (including the attributes and their benefits) and data of their claimed NFT without initiating any Web3 procedures.

Process 300 and process 1000 have described above as implemented using Web2 technology alone. The following describes a system to integrate, in a mutually consistent manner, such Web2 processes with the creation (i.e., minting) and management of a Web3 asset (e.g., a collection and its NFTs) on a blockchain.

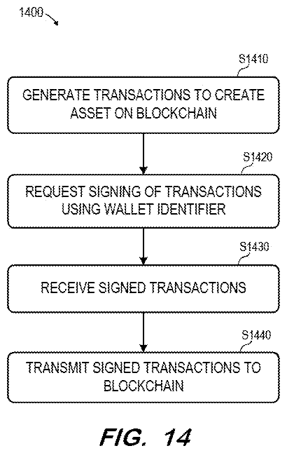

FIG. 14 is a flow diagram of a process for creating a Web3 asset such as an NFT on a blockchain according to some embodiments. It will be assumed that metadata and data of an asset has been defined and stored in tenant data 122 and blob storage 124 as described above. Asynchronous to such storage, and based on any suitable trigger (e.g., time-based, batch-based) one or more transactions to create the asset on a specified blockchain are generated at S1410.

In the present example, the one or more transactions may comprise an interaction with a factory smart contract for creating a collection that causes cloning of the factory smart contract on the blockchain, and a transaction to associate an identifier of an NFT with the collection. In some embodiments of S1410, Web server 120 generates a HyperText Transfer Protocol (HTTP) RPC call for each transaction which specifies the transaction and includes the custodial tenant wallet identifier.

The call is transmitted to Web3 interface 130, which transmits a request to key vault 150 at S1420 to sign the transactions using the private key associated with the wallet identifier. The key vault signs the transactions with the private key and returns the signed transactions for receipt at S1430. The signed transactions are then transmitted to the blockchain at S1440 by, for example, transmitting JSON RPC calls which correspond to the HTTP RPC calls to a blockchain node.

Some embodiments of process 1400 further include storage of the metadata and data of the NFT on a Web3 decentralized storage system such as InterPlanetary File System (IPFS). For example, Web3 interface 130 may pull the metadata and data from tenant data 122 and blob storage 124 after receiving a gRPC call from Web server 120 and then save the metadata and data to IPFS via a data layer such as but not limited to web3.storage. Identifiers of the saved metadata and data within IPFS may be returned to Web server 120 and associated with the NFT record in tenant data 122. Moreover, Web3 interface 130 may generate and transmit a signed transaction to associate the IPFS identifiers of the saved metadata and data with the NFT on the blockchain.

It should be noted that process 1000 may proceed to allow user claiming of an asset and viewing the metadata and data of the asset via Web2 technology regardless of the status of the creation of the asset on the blockchain via process 1400. In some embodiments, tenant data 122 is updated to indicate that an asset has been minted on the blockchain once confirmation thereof is received.

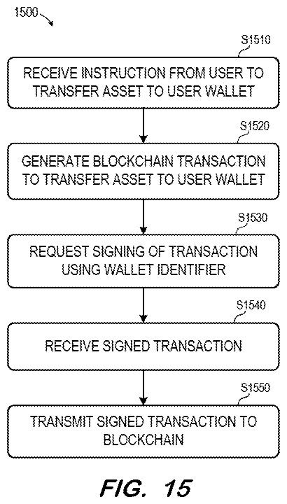

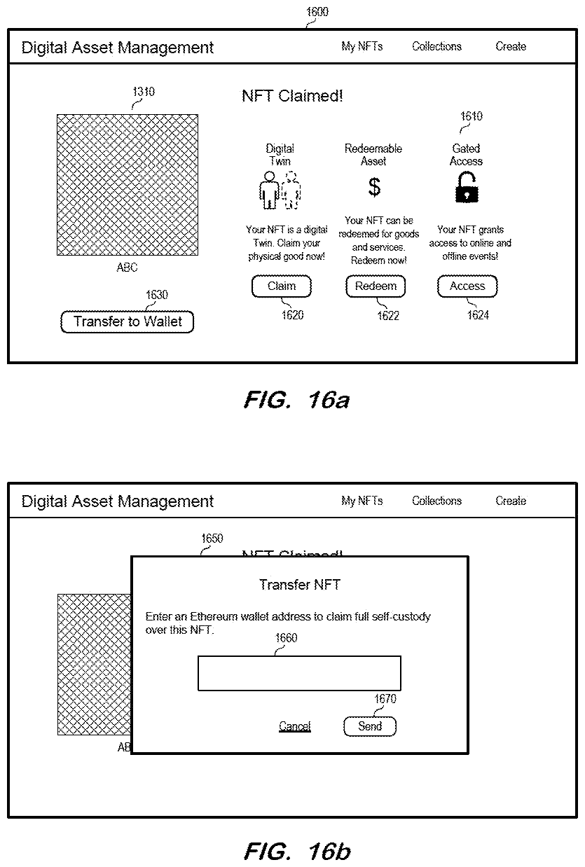

FIG. 15 is a flow diagram of process 1500 for transferring a Web3 asset from a custodial tenant wallet to a user wallet according to some embodiments. Returning to FIG. 13, it is assumed that the user selects control 1330 of interface 1300 to transmit an instruction to claim the asset. In response, interface 1600 of FIG. 16a is presented.

Interface 1600 indicates that the NFT has been claimed by the user (e.g., associated with the user's identity in tenant data 122) and also shows attributes 1610 associated with the NFT (i.e., in tenant data 122 and possibly also in Web3 decentralized storage 170). Attributes 1610 may represent a subset of the attributes associated with the NFT.

Each attribute 1610 is presented using its assigned name, icon and short description. Also presented with each attribute is a respective action button 1620, 1622 and 1624 labeled as defined in the metadata of the attribute. Selection of a button 1620, 1622 and 1624 causes transmission of an HTTP request to a link associated with the selected button in the metadata of the attribute.

Interface 1600 also provides control 1630 for transferring the NFT to a digital wallet of the user. Selection of control 1630 results in display of pop-up window 1650 of FIG. 16b. Pop-up window 1650 includes input field 1660 to receive an identifier of the user's digital wallet. The identifier may comprise a wallet address, which is a string of characters representing a hashed version of the public key of the wallet. The user inputs the wallet identifier into field 1660 and selects Send control 1670 to transmit an instruction to transfer the NFT to the user's digital wallet. The instruction is received at S1510 of process 1500.

Next, a blockchain transaction is generated at S1520 to transfer the asset from the custodial tenant wallet to the user's digital wallet. Generation of a blockchain transaction to transfer an asset between digital wallets is known in the art. For example, the transaction may interact with a smart contract associated with a collection including the asset. At S1530, Web3 interface 130 transmits a request to key vault 150 to sign the transaction using the private key associated with the custodial tenant wallet identifier. Key vault 150 signs the transaction and returns the signed transaction for receipt at S1540. The signed transaction is then transmitted to the blockchain at S1550. In some embodiments, a confirmation of the transfer is presented to the user once the blockchain has confirmed the transaction.

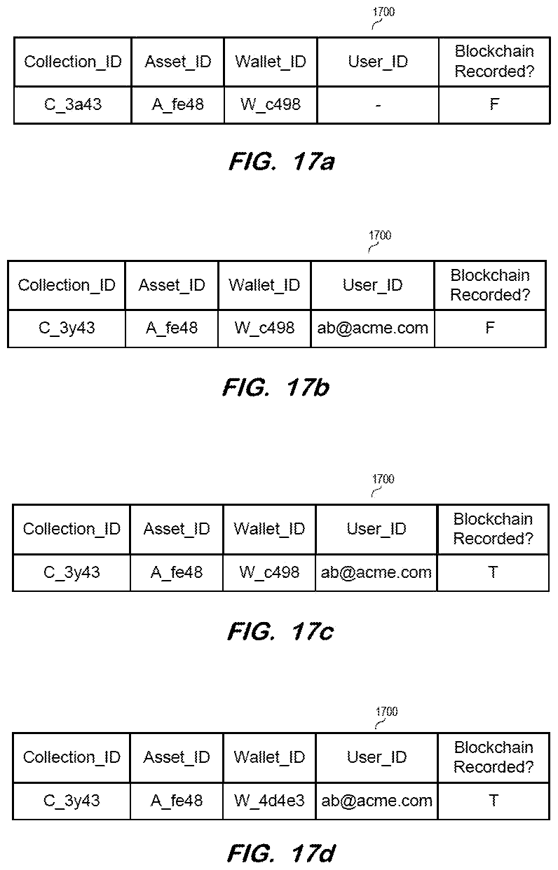

FIGS. 17a through 17d are representations of a database table of a Web2 data store storing associations between Web3 assets, users and digital wallets according to some embodiments. With reference to the above description, table 1700 may be stored in tenant data 122 and updated by Web server 120 in response to creation, claiming and transfer of Web3 assets. Embodiments are not limited to table 1700 or to the foregoing description of usage thereof.

FIG. 17a shows a record of table 1700 after creation of an asset by an administrator as described above with respect to S310 through S340 of process 300. The record includes a collection identifier, an asset identifier, and an identifier of the custodial tenant wallet. The asset has not yet been distributed to a user nor minted on the blockchain, so the user identifier field of the record is empty and the “blockchain recorded?” flag of the record is set to False.

FIG. 17b shows the record of table 1700 after the asset has been claimed by a user as described with respect to process 1000. The record now includes an identifier (i.e., an e-mail address) of the claiming user. In the present example, the asset has not yet been recorded to the blockchain, and therefore the “blockchain recorded?” flag of the record remains set to False.

FIG. 17c shows the record of table 1700 after the asset has been recorded to the blockchain, with the “blockchain recorded?” flag of the record set to True. It should be noted that the asset may be recorded to the blockchain prior to distribution to a user or claiming by a user, in which case the user identifier field of the record is empty and the “blockchain recorded?” flag of the record is set to True.

FIG. 17d illustrates the record of FIG. 17c after transfer of the associated asset from the custodial tenant wallet to a wallet of the user. Accordingly, the wallet identifier of the record has been changed from “W_c498” to “W_4d4e3”. In some embodiments, the wallet identifier of the record is changed only after confirmation of a transaction which transfers the asset on the blockchain.

According to some embodiments, table 1700 also includes metadata of attributes associated with each collection. The metadata of attributes associated with a collection may be stored in one or more other tables and indexed by collection and/or asset identifiers. Using the stored data, Web server 120 may determine the benefits due to a user by virtue of the asset identifiers associated with the user. Accordingly, Web server 120 may determine and consider a particular user's benefits during the processing of any Web2 transaction (e.g., product purchase, authorization to register with a group, authorization to access online or real-world event, authorization to vote).

Processing of a Web2 transaction may take into account both a user's NFT attribute-related benefits as described herein and the user's identity in the Web2 system. For example, a first user and a second user may each own an NFT having an attribute associated with a particular product discount benefit. However, the second user is a member of a loyalty program of the Web2 system while the first user is not. If Web server 120 detects that the first user is purchasing the product, a 5% discount is applied. However, if the second user is purchasing the product, Web server 120 applies a 10% discount based on their loyalty program membership. Loyalty program membership in this example is a Web2 attribute that is not managed on the blockchain and is not an NFT attribute, yet it influences how the benefit of a same attribute is applied to different users.

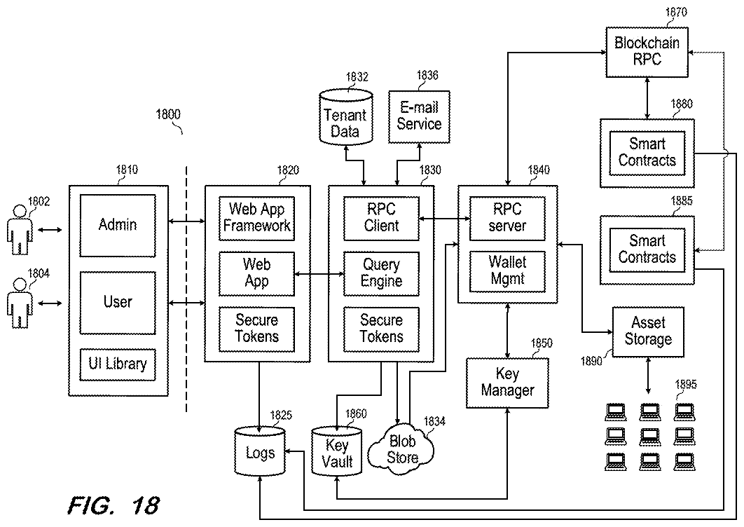

FIG. 18 is a detailed block diagram of system 1800 to manage Web3 assets using Web2 technology according to some embodiments. System 1800 may comprise an implementation of system 100 according to some embodiments. System 1800 includes client 1810 which executes within a user device, client server 1820, API layer 1830 and Web3 interface 1840. In some embodiments, client server 1820, API layer 1830 and Web3 interface 1840 are deployed as Docker containers using Kubernetes. Client server 1820, API layer 1830 and Web3 interface 1840, as well as key manager 1850, may be deployed in the same on-premise backend.

Client 1810 may comprise a single page application using a UI library such as React, for example. The single page application may support an administrator experience for administrator 1802 and a user experience for user 1804. Client 1810 may be served by a Web application of client server 1820 built on a Web application framework such as Next.js. The Web application of client server 1820 or the single page application of client 1810 may communicate with API layer 1830 via an API query language such as GraphQL and leverages secure tokens (e.g., Web tokens) for user authentication, user authorization, and multi-tenancy.

API layer 1830 supports client experiences with a traditional Web2 data source, while also passing through and staying in sync with Web3 data through Web3 interface 1840. API layer 1830 may comprise a traditional Software-as-a-Service application providing user and account management, Web2 data models and data storage, and multitenancy support. API layer 1830 allows access through the secure tokens (e.g., PASETO tokens, JSON Web Tokens), saves transactional data into tenant data 1832 and blob store 1834, sends outgoing e-mails via e-mail service 1836 (e.g., SendGrid) and runs an RPC (e.g., gRPC) client to communicate with Web3 interface 1840. The secure tokens store information regarding the user, the tenant, and the user's role. All queries may be authenticated and authorized using the token information rather than API arguments.

Web3 interface 1840 is a stateless service that handles interactions with blockchains 1880 and 1885. For example, Web3 interface 1840 may transmit signed transactions to blockchains 1880 and 1885. The transactions may, for example, create an asset, transfer an asset, create a smart contract, or interact with a smart contract. In the latter regard, Web3 interface 1840 provides transactions needed to execute the functionality of the created smart contracts so that API layer 1830 can call that functionality via Web3 interface 1840.

Web3 interface 1840 may communicate with blockchains 1880 and 1885 via blockchain RPC 1870. Embodiments are not limited to two blockchains. Blockchain RPC 1870 may be provided by a 3rd party (e.g., Alchemy) but embodiments are not limited thereto. Web3 interface 1840 may comprise a Rust server which communicates with API layer 1830 through gRPC, where Protocol Buffers define the API contracts between Web3 interface 1840 and API layer 1830.

Web3 interface 1840 communicates with asset storage layer 1890 to store metadata and data of Web3 assets in decentralized storage 1895. Decentralized storage may comprise IPFS, and layer 1890 may comprise web3.storage in some embodiments.

Web3 interface 1840 provides management of tenant (i.e., custodial tenant) and user wallets. Wallet management includes wallet creation, funds transfer, and other functionalities. Wallet management also includes orchestration of blockchain transaction signing using a private key associated with a wallet. Web3 interface 1840 communicates with key manager 1850 to perform such signing. Key manager 1850 may comprise a trusted open-source key management solution such as Consensys Quorum Key Manager but embodiments are not limited thereto.

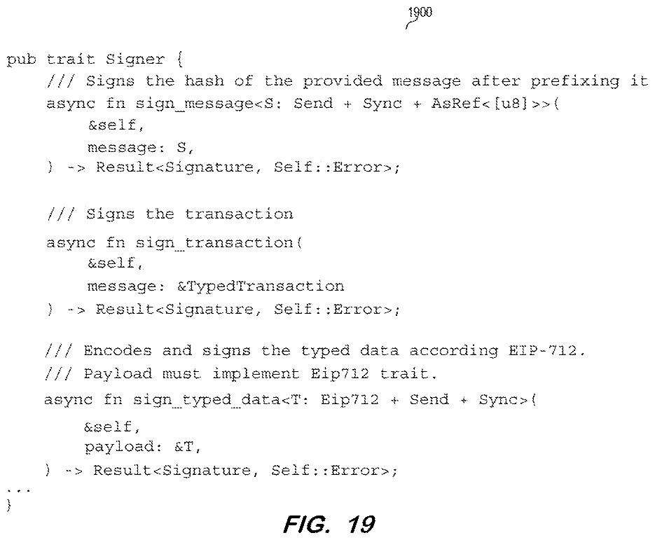

Key manager 1850 may implement a remote signing utility which is called by Web3 interface 1840 to request signing of a transaction. FIG. 19 is an example of code 1900 of a remote signing utility of key manager 1850 using the ethers-signer trait according to some embodiments. Key manager 1850 may in turn request signing of a transaction using a private key stored in key vault 1860.

A clone factory contract (e.g., EIP-1167) for each smart contract to be used may be deployed on blockchains 1880 and 1885. A clone factory contract is called by Web3 interface 1840 to clone new smart contracts on its blockchain. The clone factory contracts may leverage open-source libraries (e.g., OpenZeppelin) and may comprise Solidity smart contracts in the case of the Ethereum blockchain.

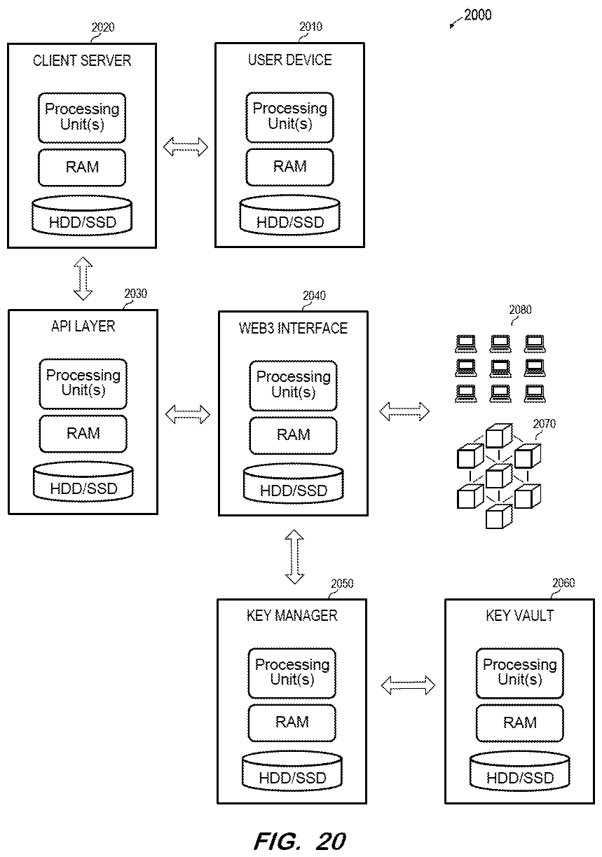

FIG. 20 is a block diagram of cloud-based architecture 2000 according to some embodiments. Client server 2020, API layer 2030, Web3 interface 2040, and key manager 2050 may comprise cloud-based compute resources, such as one or more virtual machines, allocated by a public cloud provider providing self-service and immediate provisioning, autoscaling, security, compliance and identity management features. Client server 2020, API layer 2030, Web3 interface 2040, and key manager 2050 may execute containerized applications deployed in Docker containers on Kubernetes. A user may operate user device 2010 to interact with client server 2020 via a Web2 paradigm. The remaining components of architecture 2000, including key vault 2060, may operate as described above to transmit transactions to blockchain 2070 and store metadata and data of Web3 assets in decentralized storage 2080.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing executable program code; and
at least one processing unit to execute the program code to cause the system to:
receive a request at a Web server to create a Web3 asset on a Web3 database, the Web3 asset associated with metadata of one or more attributes;
in response to the received request:
generate an encrypted operation to create the Web3 asset on the Web3 database; and
transmit the encrypted operation to the Web3 database;
receive an instruction at the Web server to assign the Web3 asset to a user;
in response to the instruction, store a user identifier of the user in association with an identifier of the Web3 asset and the metadata;
receive, at the Web server, a user request to claim a benefit of one of the one or more attributes;
in response to the user request, determine at the Web server that the user is associated with the Web3 asset based on the stored user identifier; and
in response to the determination that the user is associated with Web3 asset, provide the benefit to the user.

2. The system according to claim 1, the at least one processing unit to execute the program code to cause the system to:
receive, at the Web server, a second user request to claim a second benefit of a second one of the one or more attributes;
in response to the second user request, determine at the Web server that the user is associated with the Web3 asset based on the stored user identifier; and
in response to the determination in response to the second request that the user is associated with the Web3 asset, provide the second benefit to the user.

3. The system according to claim 1, where the Web3 asset is associated with metadata of one or more attributes and with a second stored user identifier, the at least one processing unit to execute the program code to cause the system to:
receive, at the Web server, a second user request from a second user to claim the benefit of the one of the one or more attributes;
in response to the second user request, determine at the Web server that the second user is associated with the Web3 asset based on the stored second user identifier; and
in response to the determination that the second user is associated with the Web3 asset, provide the benefit to the second user.

4. The system according to claim 1, wherein the user identifier of the user is stored in association with an identifier of the Web3 asset, the metadata and a key identifier, and wherein the encrypted operation is encrypted using a private key associated with the key identifier.

5. The system according to claim 4, the at least one processing unit to execute the program code to cause the system to:
receive a request at the Web server from the user to transfer the Web3 asset to a second key identifier associated with the user; and
in response to the received request to transfer the Web3 asset to the user:
generate a second encrypted operation to transfer the Web3 asset to the user on the Web3 database, where the encrypted second operation is encrypted using the private key;
transmit the second encrypted operation to the Web3 database; and
store the second key identifier in association with the user identifier, the identifier of the Web3 asset and the metadata.

6. The system according to claim 1, the at least one processing unit to execute the program code to cause the system to:
receive a request at the Web server from the user to transfer the Web3 asset to a second key identifier associated with the user; and
in response to the received request to transfer the Web3 asset to the user:
generate a second encrypted operation to transfer the Web3 asset to the user on the Web3 database;
transmit the second encrypted operation to the Web3 database; and
store the second key identifier in association with the user identifier, the identifier of the Web3 asset and the metadata.

7. A method comprising:
receiving a request at a Web server to create a Web3 asset on a Web3 database, the Web3 asset associated with metadata of one or more attributes;
in response to the received request:
generating an operation to create the Web3 asset on the Web3 database; and
transmitting the operation to the Web3 database;
receiving an instruction at the Web server to assign the Web3 asset to a user;
in response to the instruction, storing a user identifier of the user in association with an identifier of the Web3 asset and the metadata;
receiving, at the Web server, a user request to claim a benefit of the one or more attributes;
in response to the user request, determining at the Web server that the user is associated with the Web3 asset based on the stored user identifier; and
in response to the determination that the user is associated with the Web3 asset, providing the benefit to the user.

8. The method according to claim 7, further comprising:
receiving, at the Web server, a second user request to claim a second benefit of a second one of the one or more attributes;
in response to the second user request, determining at the Web server that the user is associated with the Web3 asset based on the stored user identifier; and
in response to determining that the user is associated with the Web3 asset, providing the second benefit to the user.

9. The method according to claim 7, where the Web3 asset is associated with metadata of one or more benefits and with a second stored user identifier, the method further comprising:
receiving, at the Web server, a second user request from a second user to claim a second benefit of one of the one or more attributes;
in response to the second user request, determining at the Web server that the second user is associated with the Web3 asset based on the stored second user identifier; and
in response to determining that the second user is associated with the Web3 asset, providing the second benefit to the second user.

10. The method according to claim 7, wherein the user identifier of the user is stored in association with an identifier of the Web3 asset, the metadata and a key identifier, and wherein the operation is encrypted using a private key associated with the key identifier.

11. The method according to claim 10, further comprising:
receiving a request at the Web server from the user to transfer the Web3 asset to a second key identifier associated with the user; and
in response to the received request to transfer the Web3 asset to the user:
generate a second operation to transfer the Web3 asset to the user on the Web3 database, where the second operation is encrypted using a private key associated with the key identifier;
transmit the second encrypted operation to the Web3 database; and
store the second key identifier in association with the user identifier, the identifier of the Web3 asset and the metadata.

12. The method according to claim 7, further comprising:
receive a request at the Web server from the user to transfer the Web3 asset to a key identifier associated with the user; and
in response to the received request to transfer the Web3 asset to the user:
generate a second operation to transfer the Web3 asset to the user on the Web3 database;
transmit the second operation to the Web3 database; and
store the second key identifier in association with the user identifier, the identifier of the Web3 asset and the metadata.

13. A non-transitory medium storing program code executable by at least one processing unit of a computing system to cause the computing system to:
receive a request at a Web server to create a Web3 asset on a Web3 database, the Web3 asset associated with metadata of one or more attributes;
in response to the received request:
generate an operation to create the Web3 asset on the Web3 database; and
transmit the operation to the Web3 database;
receive an instruction at the Web server to assign the Web3 asset to a user;
in response to the instruction, store a user identifier of the user in association with an identifier of the Web3 asset and the metadata;
receive, at the Web server, a user request to claim a benefit of one of the one or more attributes;
in response to the user request, determine at the Web server that the user is associated with the Web3 asset based on the stored user identifier; and
in response to the determination that the user is associated with the Web3 asset, provide the benefit to the user.

14. The medium according to claim 13, the program code executable by at least one processing unit of a computing system to cause the computing system to:
receive, at the Web server, a second user request to claim a second benefit of one of the one or more attributes;
in response to the second user request, determine at the Web server that the user is associated with the Web3 asset based on the stored user identifier; and
in response to the determination that the user is associated with the Web3 asset, provide the second benefit to the user.

15. The medium according to claim 13, where the Web3 asset is associated with metadata of one or more benefits and with a second stored user identifier, the program code executable by at least one processing unit of a computing system to cause the computing system to:
receive, at the Web server, a second user request from a second user to claim a second benefit of the one or more attributes;
in response to the second user request, determine at the Web server that the second user is associated with Web3 asset based on the stored second user identifier; and
in response to the determination that the second user is associated with Web3 asset, provide the second benefit to the second user.

16. The medium according to claim 13, wherein the user identifier of the user is stored in association with an identifier of the Web3 asset, the metadata and a key identifier, and wherein the operation is encrypted using a private key associated with the key identifier.

17. The medium according to claim 16, the at least one processing unit to execute the program code to cause the system to:
receive a request at the Web server from the user to transfer the Web3 asset to a second key identifier associated with the user; and
in response to the received request to transfer the Web3 asset to the user:
generate a second encrypted operation to transfer the Web3 asset to the user on the Web3 database, where the encrypted second operation is encrypted using the private key;
transmit the second encrypted operation to the Web3 database; and
store the second key identifier in association with the user identifier, the identifier of the Web3 asset and the metadata.

18. The medium according to claim 13, the at least one processing unit to execute the program code to cause the system to:
receive a request at the Web server from the user to transfer the Web3 asset to a second key identifier associated with the user; and
in response to the received request to transfer the Web3 asset to the user:
generate a second operation to transfer the Web3 asset to the user on the Web3 database;
transmit the second operation to the Web3 database; and
store the second key identifier in association with the user identifier, the identifier of the Web3 asset and the metadata.
